(19) United States
(12) Patent Application Publication
(10) Pub. No.: US 2010/0225779 A1
(43) Pub. Date: Sep. 9, 2010

(54) Method and Device to extend camera battery life

(75) Inventor: Mikko J. Muukki, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/381,152

(22) Filed: Mar. 6, 2009

(51) Int. Cl. H04N 9/73; H04N 5/225

(52) U.S. Cl. 348/223.1; 348/372; 348/E09.051; 348/E05.024

(57) ABSTRACT

The battery power consumption in a camera is adjustable based on the level of camera activity determined from formation on scene changes. Information can be gathered from statistical data on auto-white balance, auto-exposure and auto-focusing calculations, or from scene movement and camera movement. When the activity level is low, the viewfinder frame rate can be reduced, the accuracy of analog-to-digital conversion in the camera can be reduced, and the entire camera operation can be slowed down.

### FIELD OF THE INVENTION

The present invention relates generally to a camera and, more particularly, to a camera having an image display used as a viewfinder.

### BACKGROUND OF THE INVENTION

A digital camera usually has an image display used as a viewfinder to allow a user to view an image of the scene before taking a picture of the scene. Displaying an image of the scene consumes the power of the camera battery. It is advantageous to provide a method for controlling the display of an image on the viewfinder in order to lower the battery power consumption and thus extend the camera battery life.

### SUMMARY OF THE INVENTION

The present invention provides a method and apparatus for reducing the battery power consumption in a camera using a number of power saving features. The apparatus uses information regarding scene movement, for example, to detect level of activity of the camera and uses the level of activity as a basis for reducing the power consumption when the camera viewfinder is active. Scene movement can be determined from color information, scene light level information, statistical information gathered from image data, for example. Statistical data can be obtained from auto white balance, auto exposure and auto focus algorithms, for example. Scene light level information can also be obtained from an ambient light sensor.

The level of activity can be used to control the viewfinder frame rate, to control analog-to-digital converter modes, to slow down the entire camera operation, or to turn off some unnecessary blocks when the activity is below a certain level.

Thus, the first aspect of the present invention is a method, which comprises:

determining a level of camera activity; and

controlling consumption of electrical power for use in an imaging device at least partly based on the level of camera activity.

The level of camera activity can be determined at least partly based on movement of the imaging device.

The level of camera activity can be determined at least partly based on a user activity on the imaging device.

The level of camera activity can be determined at least partly based on a change in the image data.

The level of camera activity can be determined at least partly based on the statistical data in white-balance conversion in the image data.

The level of camera activity can be determined at least partly based on the change of the image data in the exposure adjustment on the image.

The level of camera activity can be determined at least partly based on the change of the image data in the focus adjustment on the image.

The second aspect of the present invention is an apparatus, which comprises:

a data processing module configured to process image data indicative of an image of a scene, and

an information collection module for determining a level of camera activity at least partly based on a change in the image data, wherein the level of camera activity is used for controlling consumption of the power in the apparatus.

According to one embodiment of the present invention, the apparatus comprises

a detection module for detecting a movement of the apparatus, wherein the information collection module is further configured for determining the level of camera activity based on the movement of the apparatus. Alternatively, the change in the image data is indicative of a change of lighting of the scene, or the change of the scene.

According to another embodiment of the present invention, the apparatus comprises a control module for carrying out exposure and/or focus adjustment of the image, wherein the change in the image data is indicative of the exposure and/or focus adjustment.

The consumption of power can be controlled by controlling the data processing rate, the rate for carrying out exposure adjustment and/or focus adjustment.

The consumption of power can be controlled by controlling an update rate for displaying the image data.

The third aspect of the present invention is a computer readable storage medium embedded therein a software program, said software program comprising programming codes for:

collecting information indicative of a change in an image of a scene;

determining a level of camera activity in an imaging device at least partly based on the information; and

controlling consumption of electrical power in the imaging device at least partly based on the level of camera activity.

The fourth aspect of the present invention is an apparatus, which comprises:

means for collecting information indicative of a change in an image of a scene;

means for determining a level of camera activity in an imaging device at least partly based on the information; and

means for controlling consumption of electrical power for use in the imaging device at least partly based on the level of camera activity.

According to one embodiment of the present invention, the image data comprises white-balanced image data converted from raw data in a white-balance calculation process, and the apparatus further comprises:

means for adjusting a rate for the white-balance calculation process for controlling said consumption.

According to another embodiment of the present invention, the apparatus further comprises means for detecting a movement of the apparatus, wherein the level of camera activity is determined at least partly based on the movement of the apparatus.

The level of camera activity can be partly determined based on statistical information on white-balance calculation, on auto-exposure calculation and on auto-focus calculation.

The level of computation activity can be used to control the rate or complexity in white-balance calculation, on auto-exposure calculation and on auto-focus calculation.

According to various embodiments of the present invention, the changes in the image are indicative of movement of the scene, and the method further comprises detecting changes in illumination of the scene for providing the information indicative the changes in the image.

The present invention will become apparent upon reading the description taken in conjunction with FIGS. 1-7.

### BRIEF DESCRIPTION OF THE DRAWINGS

FIG. 1 is a block diagram showing a camera system, according to one embodiment of the present invention.

FIG. 2 shows the components in the image signal processing module for processing image data from a digital camera and the connection to various modules.

FIG. 3 is a block diagram showing a camera system, according to another embodiment of the present invention.

FIG. 4 is a block diagram showing a camera system, according to a different embodiment of the present invention.

FIG. 5 is a block diagram showing a camera system, according to yet another embodiment of the present invention.

FIG. 6 shows an electronic device having a camera system, according to various embodiments of the present invention.

FIG. 7 shows an analog-to-digital converter associated with a camera.

### DETAILED DESCRIPTION OF THE INVENTION

Whenever a digital camera is turned on, it consumes battery power. Displaying an image on a viewfinder requires battery power, for example. It is desirable to reduce the battery power consumption by controlling the display of an image on the viewfinder.

Some camera systems have a timer to set the camera to a lower power stage in order to save battery power. To get back from this stage to a normal operation stage requires the user either to activate the camera again or to press a button. This getting-back procedure delays the image taking momentum as a user usually wants to take an image immediately after picking up the camera.

The present invention provides a method for reducing battery power consumption in a camera, wherein the input from the user is not necessary and image taking can be carried out without delay. According to various embodiments of the present invention, the camera viewfinder is automatically and adaptively controlled in order to save battery power.

Power saving features, according to embodiments of the present invention, use environment information to detect the level of activity of the camera and use the level of activity as a basis for reducing the power consumption when camera viewfinder is active. The level of activity includes scene movement and camera movement, for example.

Scene movement can be determined from color information and scene light level information gathered on image data, for example. Thus, when there are a lot of changes in the color and/or in the scene light level in the image data, the level of activity is assumed high. Scene movement can also be determined from movement vector calculation and from statistical data. Statistical data can be obtained from auto white balance, auto exposure and auto focus algorithms, for example. Scene light level information can also be obtained from an ambient light sensor.

Camera movement can be determined from the statistical data or from the movement amount detected by a motion detection device such as an accelerometer. Alternatively, camera movement can be determined by computing motion vectors from a number of frames.

The level of activity can be used to control the viewfinder frame rate, to control ADC (analog-to-digital converter) modes, to slow down the entire camera operation, or to turn off some unnecessary blocks, when the activity is below a certain level. For example, some image processing blocks for auto white balance calculation, auto exposure calculation and auto focus calculation can be slowed down. The viewfinder frame rate can be kept at a normal level (at 30 fps, for example) when the level of activity is high and reduced when the level is low. It is possible to operate the ADC in a less accuracy mode (8 bits, instead of 10 bits, for example) for sub-sampling, for example, such that the ADC does not convert all pixels, or some pixels are skipped. The power consumption of the ADC may also be further reduced as a trade-off on image quality. In sum, it is desirable in some instances that the camera operation is slowed down, some of the processing algorithms can be selectively turned off or slowed down as a trade-off on image quality. If the frame rate has to be reduced, some of the processing blocks can be turned off or slowed down while other processing blocks can maintain the normal activity level, based on the processor load, for example. The reduction of the viewfinder frame rate can reduce battery power consumption. The frame rate can be 5 frames per second, for example, when the environment information indicates a very low level of activity. Such a low frame rate usually does not have a negative affect on usability if the activity is low.

Even when the camera is operated in a slowed-down mode, the environment information is still monitored. Once the changes in environment information reach a certain level, the viewfinder frame rate can be accelerated in order to have fluent viewfinder and, at the same time, auto white balance calculation, auto exposure calculation and auto focus calculation can be returned to normal.

In addition, it is advantageous that the system has built-in safe operation periods to balance the end-user experience. For example, the camera is configured to use a high frame rate during the first few seconds when the camera is turned on. This is the period when the user is most likely to take pictures. This initial high frame rate is designed to ensure a quick response time when the loops for auto white balance, auto exposure and auto focus are active. If an image is not taken during this initial period, power saving features can be automatically carried out.

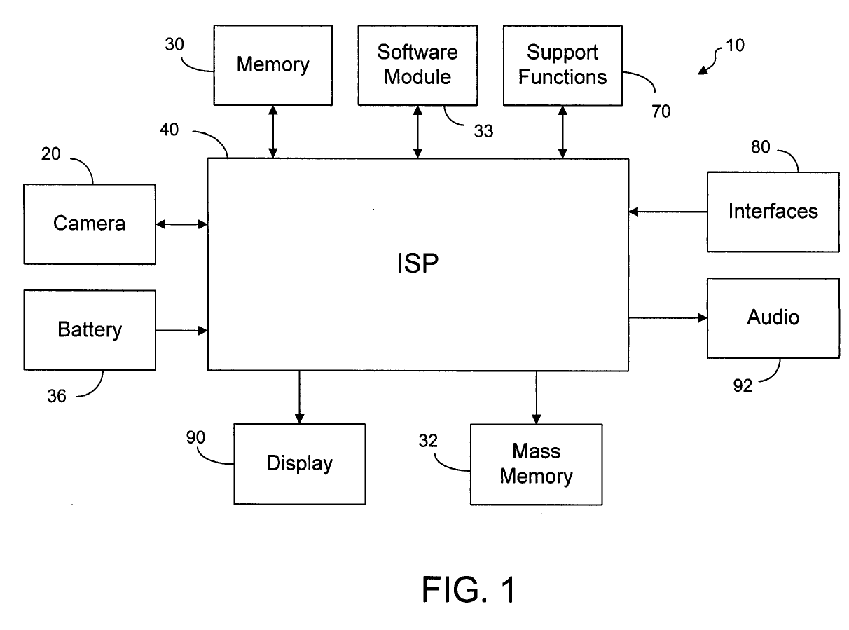

FIG. 1 illustrates a camera system, according to one embodiment of the present invention. As shown in FIG. 1, the camera system 10 comprises a camera 20 which supplies image data to an image signal processing (ISP) module 40. A memory 30 is coupled to the image signal processing module 40 for storing image data to be processed. After the image data is processed, they can be stored in a mass memory 32. The image data can also be displayed on a display module 90. A number of input devices, such as movement sensor, ambient light sensors, and shutter release button can be grouped into an interface module 80. It is advantageous that an audio module 92 is connected to the processing module 40 for producing sounds to indicate the status of camera functions, such as completion of the autofocus function. A support module 70 is also connected to the processing module 40 to carry out support functions. For example, the support module 70 may comprise an electronic flash unit. Most, if not all, of the components in the camera system 10 will use the power provided by a battery 36 when the camera is turned on. The camera system 10 also comprises a software module 33 to provide a variety of algorithms to allow the image processing module 40 to carry out auto-exposure, auto-white balance and auto-focus calculations, to carry out motion vector calculation for detecting scene movement, to carry out camera movement detection based on image data from a plurality of image frames, and to collect statistical information, for example. The software module 33 comprises a computer readable storage medium to embed programming codes for those algorithm, for example.

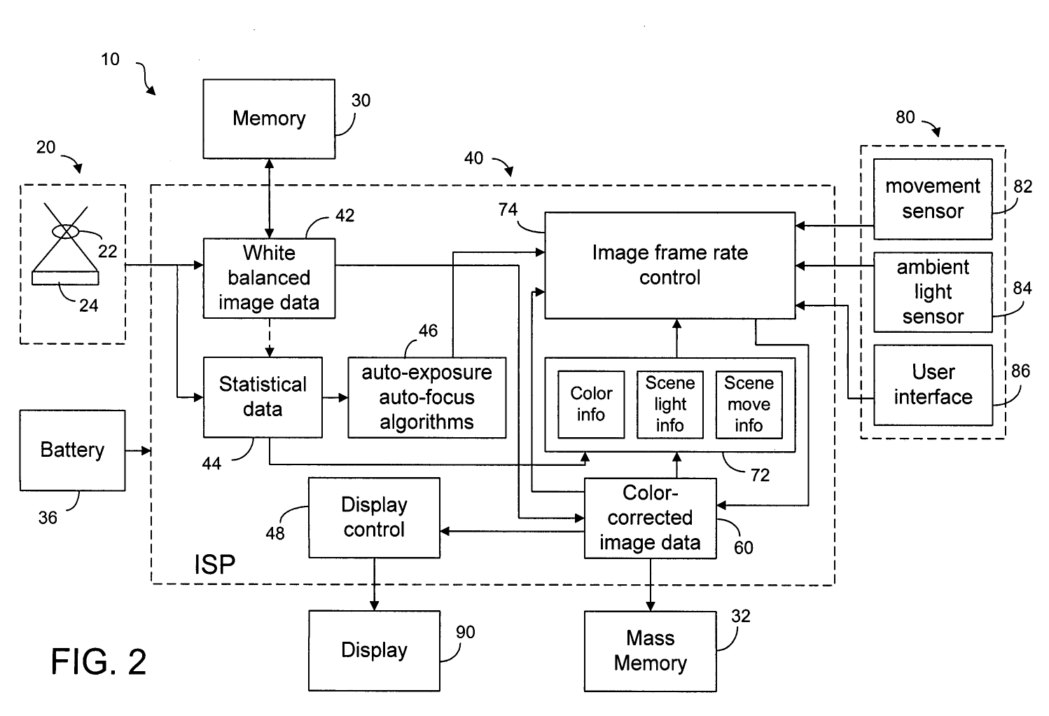

The core of the present invention is in the image signal processing module 40. As shown in FIG. 2, the camera 20 can be a digital camera with an imaging lens 22 for forming an image on an image sensor 24. The image signal processing module 40 is arranged to receive raw image data from the camera module 20. The received image data can be stored in the memory 30, for example. The raw image data received from the camera 20 is processed by a white balance module 42 to become white-balanced processed data. The white-balanced processed data can be directly provided to a color correction module 60 for color adjustment. Alternatively, the white-balance process data is stored in memory 30 so that color correction can be performed in a different time and/or in a separate color correction module. The output of the color correction module 60 is color-corrected image data which can be stored in the mass memory module 32 and provided to a viewfinder or image display 90 through a display control module 48, so as to allow a user to see an image of a scene before and after image capturing. The image signal processing module 40 further comprises a module 44 to collect statistical data related to auto-exposure, automatic white-balance (AWB) and auto-focus calculation, and a module 46 to carry out auto-exposure, auto-white balance and auto-focus calculations. The statistical data related to white-balance can be provided by the white-balanced image data from the block 42 or gathered from the raw image data from the camera 20. The color-corrected image data from module 60 and the statistical data from the module 44 can be used in a module 72 to gather scene color information, scene light level information and scene movement information, for example. Based at least on the statistical data from module 44, the status of auto-exposure, auto-white balance (AWB) and auto-focus calculations from module 46, together with various information from module 72, the level of camera activity is determined by a module 74. Based on the level of camera activity, the module 74 determines the frame rate for updating the viewfinder images, for example.

It should be noted that the camera 20 is generally equipped with an analog-to-digital converter 26 to convert analog image data 124 into digital image data 126 before providing the image data to the white balanced image data module 42, as shown in FIG. 7.

The camera system 10 may have an ambient light sensor 84 to detect the changes in the scene light level and in the scene color, and a movement sensor 82 to detect the camera movement. Information from the ambient light sensor 84 and the movement sensor 82 can also be used to estimate the level of camera activity by the module 74.

The camera system 10 may include a user interface 86 to allow the user to override certain features of the camera. The user may decide to turn off the viewfinder without turning off the camera power, for example.

In the embodiment as shown in FIG. 2, the scene color information, scene light level information and scene movement information are gathered from the color-corrected image data provided by module 60. According to a different embodiment of the present invention, scene color information, scene light level information and scene movement information are gathered from the white-balanced image data from module 42, for example.

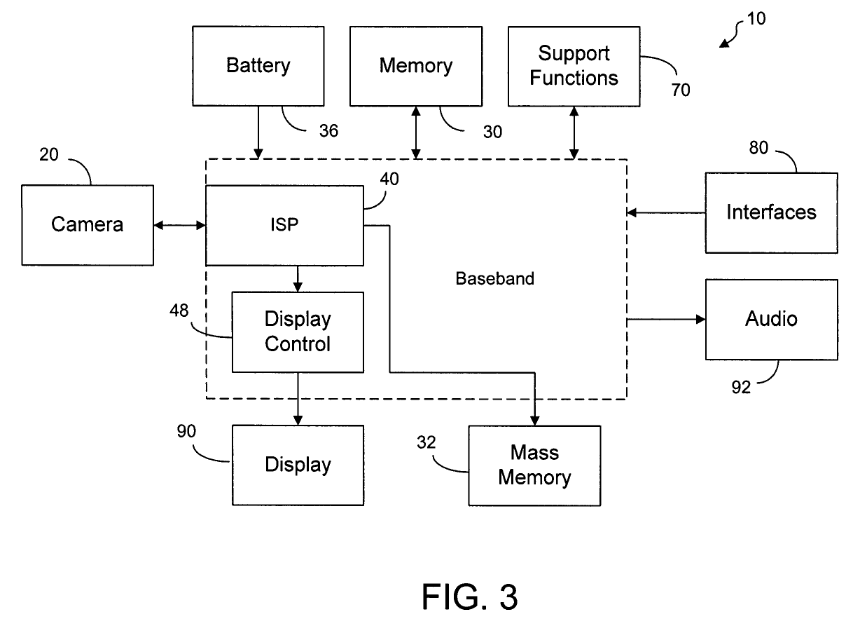

It should be noted that the coupling of the image signal processing module 40 to various modules in the camera system 10 can be arranged differently. For example, the display control module 48 can be separated from the image signal processing module 40 and become a part of a camera baseband. As shown in FIG. 3, only the camera 20, the mass memory 32 and the display control module 48 are directly connected to the image signal processing module 40. All the other modules, such as the memory 30, the support functions module 70, the interface module 80 and the audio module 92 are connected to the baseband.

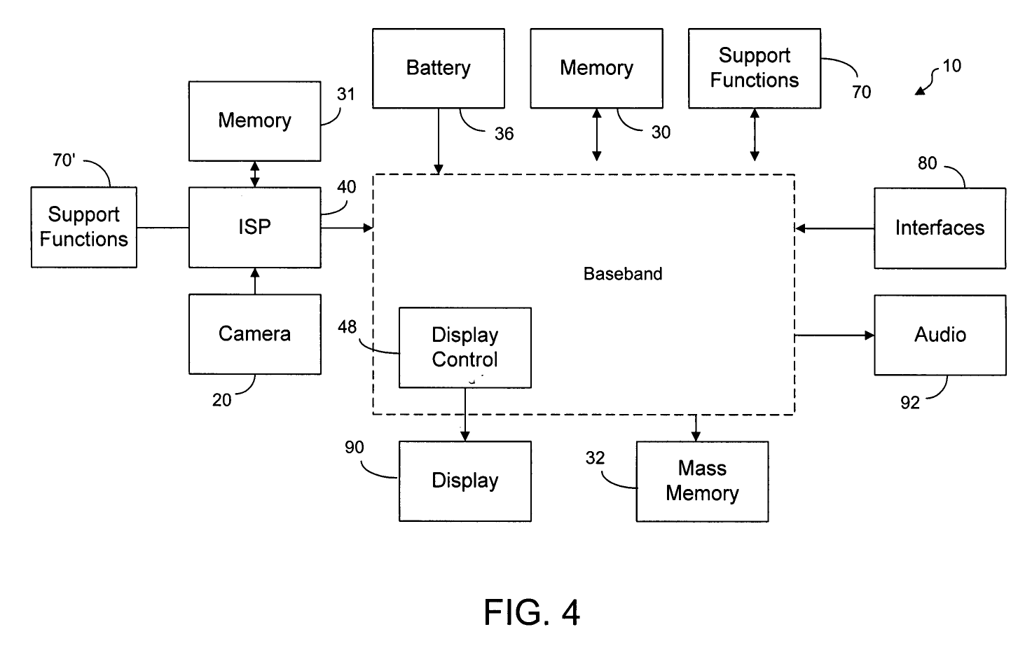

In a different embodiment, the image signal processing module 40 can be further removed from the baseband, as shown in FIG. 4. As shown in FIG. 4, an additional memory module 31 is directly coupled to the image signal processing module 40 for storing image data to be processed. Some of the support functions, such as camera flash, can be provided to the image signal processing module 40 from a support function module 70′.

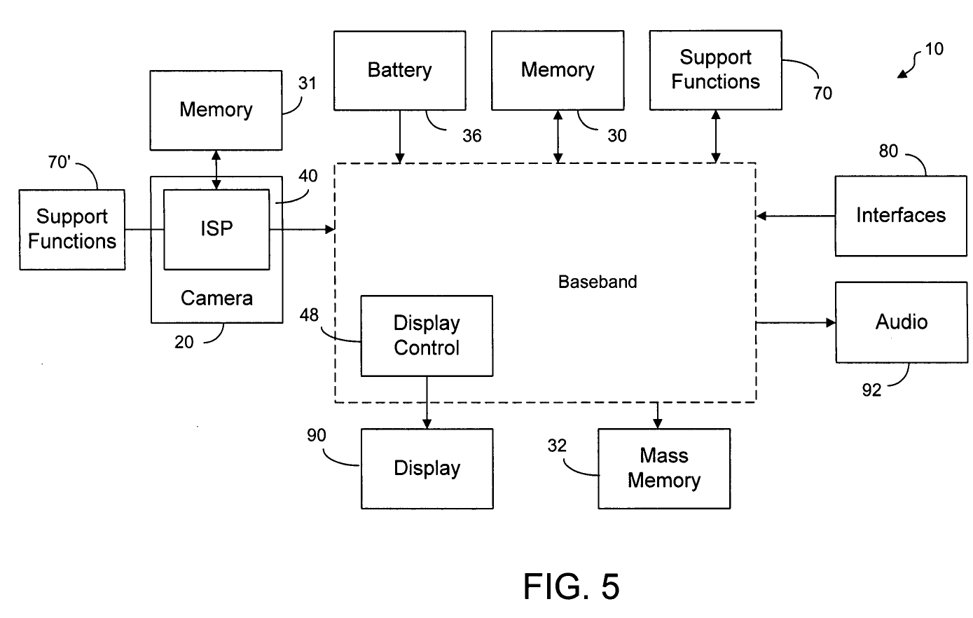

In yet another embodiment of the present invention, the image signal processing module 40 is integrated into the camera 20, as shown in FIG. 5. Some of the support functions, such as camera flash, can be provided to the image signal processing module 40 from a support function module 70′.

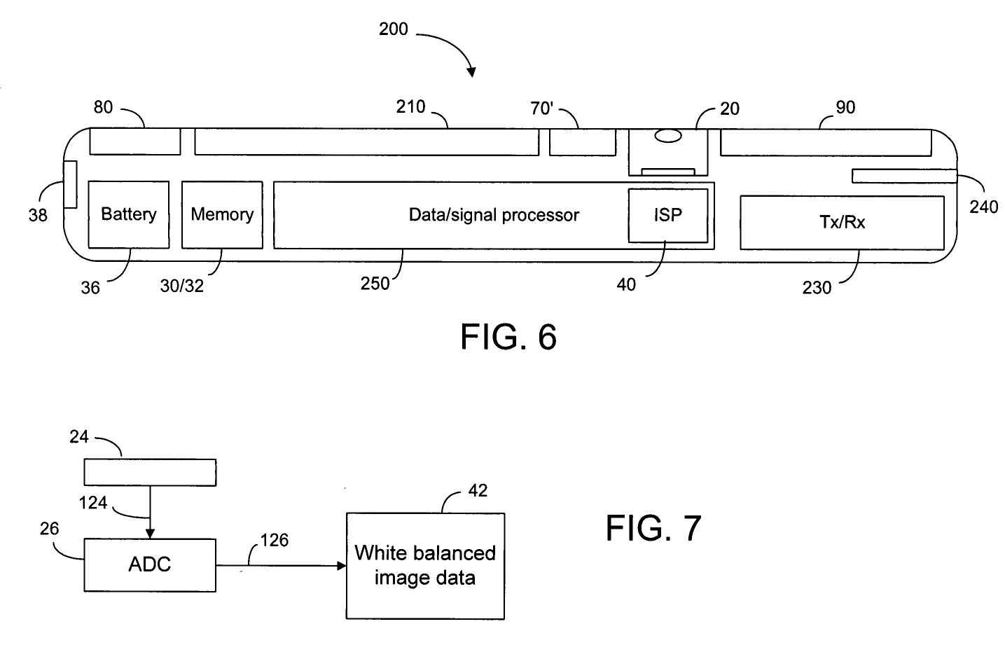

The present invention can be used in a stand-alone camera or can be integrated into another device. For example, the camera 20 along with the image signal processing module 40, the interface module 80, the mass memory 32 and the support functions 70′ can be used in an electronic device 200, as shown in FIG. 6. The electronic device 200 can be a gaming console, a personal digital assistant, a mobile terminal or the like. The electronic device 200 may already have a display module 90 and a battery 36 and may also have a keyboard 210, a data/signal processor 250, a transceiver 230 for receiving or transmitting communications data via an antenna 240. The image processing module 40 can be used to save the power consumption in the electronic device, especially when the camera 20 is used to take pictures. The electronic device 200 also includes an on/off switch 38 to turn on and off the electronic device 200, as well as the camera 20. It is possible that when the camera 20 is turned on, the power saving features, according to the present invention, will not be used with a short-period of time, say, one to five seconds. This initial short-period of time is considered as a built-in safe operations period. After this period, the power saving features can start to take effect.

In sum, the present invention provides a method and apparatus for saving power consumption in an image capturing device, such as a digital camera. The power consumption can be reduced by reducing the viewfinder frame rate, reducing the accuracy of the analog-to-digital conversion, slowing down the entire camera operation and turning off some necessary processing blocks in the camera. The power consumption can be based on the level of camera activity. The level of camera activity can be measured based on camera movement and scene movement, for example. Camera movement can be determined from the statistical data or from the movement amount detected by a motion detection device, such as an accelerometer. Scene movement can be determined from color information, scene light level information, movement vector calculation, and statistical information such as auto white balance, auto exposure and auto focus algorithm.

Several parameters can be used as a trigger to the reduction of power consumption: Accelerometer_speed (ACC_speed), Auto-exposure_speed (AE_speed), Auto-white-balance_speed (AWB_speed) and User_Activity (USER_ACT), for example.

ACC_speed can be measured in terms of cm/sec, for example. If the camera movement is considered small if the speed does not exceed 5 cm/sec, for example. When an accelerometer is not available in a camera, movement vector calculation from image data can be used to measure ACC_speed. AE_speed can be measured based on the change of exposure value between the previous frame and the current frame. The change can be expressed in terms of percentage, for example. AWB_speed can also be measured based on the change of white-balance between frames. When the changes in AE_speed and AWB_speed are below a certain limit, the scene movement can be considered as stable. Power consumption can be controlled accordingly. For example, when ACC_speed is low and the scene movement (based on AE_speed and/or AWB_speed) is also low, the power consumption can be reduced. When ACC_speed is low but the scene movement is high, the power consumption can be kept as normal.

USER_ACT can be determined after the auto-focus function is in a locked position (the shutter release being half-pressed) and it can be used to determine the power consumption. A few examples are given below:

1. Device or scene movement low or stable→AF starts→User removes AF lock or image is not captured→low power until AF is half-pressed. This scenario describes a possible use case when user starts camera, frames the image and focuses. However, the user decides to change the location because the image does not look good. Low power is used until user slows down or starts AF again. If conditions are stable after user slowing down, then low power mode can be enabled again.

2. Device or scene movement not low→AF starts→User removes AF lock or image is not captured→normal power operation mode. This scenario describes a possible use case when the device is moving or user is shooting a changing scene. The user frames the image and focuses. However, the user decides not to take the picture because the image doesn't look good, or the scene is changing. The user is typically moving all the time. A normal power operation mode should be maintained.

3. Device or scene movement low or stabile→AF starts→image capture→low power until AF is half-pressed. This scenario describes a possible use case when user starts camera, frames the image, and takes a picture. As the user changes location, low power is used until user slows down or AF starts again. If conditions are stable after user slowing down, then low power mode can be enabled again. It is also possible that user starts camera, frames the image and takes a picture. However, the user doesn't change the location. Low power is used until starts AF starts again or user starts moving or scene information starts changing.

4. Device or scene movement not low→AF starts→image is captured→normal power operation mode. This scenario describes a possible use case when the device is moving or user is shooting changing scene, frames the image and takes a picture. The user is typically moving all the time, thus normal power operation modes should be maintained.

The above examples illustrate how the level of camera activity can be used to control the power consumption of the camera. The level of camera activity can be measured and compared with a predetermined limit or threshold value, for example. The power consumption is determined based on the scene and/or device movement as well as the user input.

Thus, the present invention provides an apparatus, which comprises:

a data processing module configured to process image data indicative an image of a scene, and

an information collection module for determining a level of camera activity at least partly based on a change in the image data, wherein the level of camera activity is used for controlling consumption of the power in the apparatus.

The apparatus further comprises a detection module for detecting a movement of the apparatus, wherein the information collection module is further configured for determining the level of camera activity based on the movement of the apparatus.

The change in the image data can be the result of a change of lighting of the scene.

According to one embodiment of the present invention, the apparatus comprises a control module for carrying out exposure adjustment and focus adjustment of the image, wherein the change in the image data is indicative of the exposure adjustment and/or focus adjustment.

According to another embodiment of the present invention, the level of camera activity is used to control the rate for exposure adjustment, focus adjustment, the data processing rate in the imaging device, and/or the update rate for displaying the image data in a display module.

According to another embodiment of the present invention, the data processing module is configured to convert image data received from an imaging sensor, wherein the level of camera activity is used to control the accuracy in the data conversion.

According to various embodiments of the present invention, the image data is processed for providing white-balanced image data, and the apparatus further comprises a collection module for collecting information indicative of scene movement, wherein the level of camera activity is partially based on the scene movement. The information can be scene color information, scene light level information, or information in association with image exposure calculation, image focusing calculation.

Although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method, comprising:
determining a level of camera activity; and
controlling consumption of electrical power for use in an imaging device at least partly based on the level of camera activity.

2. The method of claim 1, wherein the level of camera activity is determined at least partly based on movement of the imaging device.

3. The method of claim 1, wherein the imaging device comprises a processor for processing image data indicative of an image of a scene, and wherein the level of camera activity is determined at least partly based on a change in the image data.

4. The method of claim 1, wherein the level of camera activity is determined at least partly based on a user activity on the imaging device.

5. The method of claim 3, further comprising:
collecting information indicative of white-balance conversion in the image data, wherein the level of camera activity is partly determined based on the information.

6. The method of claim 3, wherein the change in the image data is at least partly caused by exposure adjustment on the image.

7. The method of claim 3, wherein the change in the image data is at least partly caused by focus adjustment on the image.

8. An apparatus, comprising:
a data processing module configured to process image data indicative of an image of a scene, and
an information collection module for determining a level of camera activity at least partly based on a change in the image data, wherein the level of camera activity is used for controlling consumption of the power in the apparatus.

9. The apparatus of claim 8, further comprising:
a detection module for detecting a movement of the apparatus, wherein the information collection module is further configured for determining the level of camera activity based on the movement of the apparatus.

10. The apparatus of claim 8, wherein the change in the image data is indicative of a change of lighting of the scene.

11. The apparatus of claim 8, further comprising a control module for carrying out exposure adjustment of the image, wherein the change in the image data is indicative of the exposure adjustment.

12. The apparatus of claim 8, further comprising a control module for carrying out focus adjustment of the image, wherein the change in the image data is indicative of the focus adjustment.

13. The apparatus of claim 8, wherein the level of camera activity is used for controlling data processing rate in the data processing module.

14. The apparatus of claim 8, further comprising a control module for carrying out exposure adjustment of the image, wherein the level of camera activity is used for controlling a rate for exposure adjustment.

15. The apparatus of claim 8, further comprising a control module for carrying out focus adjustment of the image, wherein the level of camera activity is used for controlling a rate for focus adjustment.

16. The apparatus of claim 8, further comprising a display device for displaying the image data, wherein the level of camera activity is used for controlling an update rate for displaying the image data.

17. A computer readable storage medium embedded therein a software program, said software program comprising programming codes for:
collecting information indicative of a change in an image of a scene;
determining a level of camera activity in an imaging device at least partly based on the information; and
controlling consumption of electrical power in the imaging device at least partly based on the level of camera activity.

18. An apparatus, comprising:
means for collecting information indicative of a change in an image of a scene;
means for determining a level of camera activity in an imaging device at least partly based on the information; and
means for controlling consumption of electrical power for use in the imaging device at least partly based on the level of camera activity.

19. The apparatus of claim 18, wherein the image data comprises white-balanced image data converted from raw data in a white-balance calculation process, said apparatus further comprising:
means for adjusting a rate for the white-balance calculation process for controlling said consumption.

20. The apparatus of claim 18, further comprising:
means for detecting a movement of the apparatus, wherein the level of camera activity is determined at least partly based on the movement of the apparatus.
